(19) United States
(12) Patent Application Publication
(10) Pub. No.: US 2024/0062167 A1
(43) Pub. Date: Feb. 22, 2024

(54) System and Method for Recycling Plastic Waste

(71) Applicants: Daniel L. Bates, Manhattan Beach, CA (US); Ann Keasman, Big Bear Lake, CA (US); Christopher S. Galazzi, Orleans, MA (US); John Patrick Yonce, Scituate, MA (US)

(72) Inventors: Daniel L. Bates, Manhattan Beach, CA (US); Ann Keasman, Big Bear Lake, CA (US); Christopher S. Galazzi, Orleans, MA (US); John Patrick Yonce, Scituate, MA (US)

(73) Assignee: Clean-Seas, Inc., Manhattan Beach, CA (US)

(21) Appl. No.: 18/451,708

(22) Filed: Aug. 17, 2023

Related U.S. Application Data
(60) Provisional application No. 63/371,839, filed on Aug. 18, 2022.

(51) Int. Cl. G06Q 10/30; B29B 17/04

(52) U.S. Cl. CPC G06Q 10/30; B29B 17/04; B29B 2017/0496

(57) ABSTRACT

The present disclosure is a software method that uses data from data sensors, installed along a pyrolysis apparatus, to analyze chemical reactions based on fluid and solid chemical traits of polymers in a plastic recycling process and to use the results to determine deficiency or abundance of chemicals, relative to an ideal chemical ratio. The deficiency or abundance of chemicals is translated into a deficiency or abundance of specific polymers.

### TECHNICAL FIELD

The present disclosure relates to a system and method for securing, storing and optimally chemically converting the plastic recycling of developed nations to produce environmentally friendly commodities and clean-fuels; reduce the volume of plastic deposited into landfills; reduce incineration; mitigate the use of fossil fuel products; and assist developing nations in establishing plastic recycling and development of collection infrastructure.

### BACKGROUND OF THE INVENTION

Global plastic recycling is facing unprecedented challenges. Inadequate processing infrastructure, fewer processing locales, changing laws and conventions, and political circumstances imperil what is already a deficient response to a global problem. It is estimated that since 1950 only 9% of all of the planet's plastic has been recycled. By the same estimates (University of Wisconsin-Madison professor George Huber), 79 percent of plastic remains in the world's landfills and oceans. Discarded plastics are estimated to comprise 19% of all landfilled material and 16% of combusted material.

Developed nations, including the United States, the world's largest generator of recycled plastic, are finding disposal of this material increasingly difficult, due to expensive and inefficient processing capabilities; global conventions responding to environmental implications of international plastic export; and political constraints.

In January 2018 the People's Republic of China, which had been accepting recycled plastic from countries including the U.S., implemented its National Sword policy limiting recyclable imports. As a result, the worldwide recyclables market experienced drastic limits and fewer options for disposal, resulting in a global backlog of plastic. Some of the recyclable material has been rerouted to Southeast Asian countries but the market remains in upheaval, with, at best, plastic floating in waiting ships and at worst, illegal dumping into international waters, or incinerated.

The Basel Convention on hazardous material (Basel Convention) is an international treaty aimed at reducing the movement of hazardous material between nations. In 2019, the Basel Convention amended its treaty to regulate plastic exports. As a result, international shipment of plastic was, as of January 2021, subject to prior written consent between countries party to the convention. The U.S., as a non-party to this convention, is now subject to new liability because most countries will not accept its recycled plastic. In order to ship its recycled plastic, the U.S. must enter prior written agreements with accepting Basel party countries.

Plastic recycling is more difficult than recycling glass or other materials because plastic products are composed of a wide variety of plastic types, with varying pigments and other additives. Current mechanical recycling methods—granulating and melting the particles into pellets for further use as an existing Polymer—can be an expensive, inefficient and environmentally dirty process. The cost of disposal is rising; in some markets, it is more than US $100 per ton.

The recycling industry is beginning to implement chemical recycling using the pyrolysis process, becoming a plastic recycling system. Pyrolysis converts organic or inorganic material, under pressure and heat, in the absence of oxygen, into the component parts of new products. The oxygen-starved environment does not produce CO2 or other harmful gases. Pyrolysis can break down waste plastic Polymers into feedstocks that could be recycled into Monomers that can be further refined as Naptha Pre-Cursors, or used to create new, clean and pure materials incorporating recycled plastic through a new path of plastic circularity.

New solutions in the trade of recycled plastics focus on the responsible shipping of plastic material to countries that can adequately process it. Plastic processing can be economically valuable to host countries, creating useful commodities and bio-energies.

The Basel Convention determines the types of plastic wastes that are presumed to not be hazardous. The wastes listed in entry include: a group of cured resins, non-halogenated and fluorinated polymers, provided the waste is destined for recycling in an environmentally sound manner and almost free from contamination and other types of wastes; mixtures of plastic wastes consisting of polyethylene (PE), polypropylene (PP) or polyethylene terephthalate (PET) provided they are destined for separate recycling of each material and in an environmentally sound manner, and almost free from contamination and other types of wastes.

In order to optimize the chemical recycling process, a real time system of monitoring the precise chemical ratios of 1-7 Plastic Polymers undergoing the Pyrolysis process must be blended in a complex real time chemical ratio to insure the production of highest quality plastic pyrolysis oil. Using a software controlled manufacturing process reading real-time pyrolysis measurements, the according to a constantly shifting matrix.

These and other non-limiting features or characteristics of the present disclosure will be further described below.

### SUMMARY OF THE INVENTION

The present disclosure is a software method that uses data from data sensors, installed along a pyrolysis apparatus, to analyze chemical reactions based on fluid and solid chemical traits of polymers in a plastic recycling process and to use the results to determine deficiency or abundance of chemicals, relative to an ideal chemical ratio. The deficiency or abundance of chemicals is translated into a deficiency or abundance of specific polymers.

A number of process facilities are joined in a central communication network referred to as a Plastic Conversion Network (PCN) that is a software-controlled supply chain. Results from the first part determine deficiency or abundance of polymers required to achieve the ideal chemical ratio and inform the PCN. In the PCN, polymers in deficiency are logged as a demand and polymers in abundance are logged as available stock.

The software searches the PCN for stock to fill demand and routs the stock to the demand location.

An optimum norm in an example embodiment is chosen from the list consisting of: sulfur 10000 ppm, nitrogen 1000 ppm, chlorine 200 ppm, fluoride 5 ppm, bromine 10 ppm, asphaltenes, phosphorus 30 ppm, silicon 80 ppm, boron 2.5 ppm, barium 1 ppm, iron 5 ppm, zinc 1 ppm, sodium 2.5 ppm, nickel 1 ppm, aluminum 2.5 ppm, cadmium 1 ppm, calcium 2.5 ppm, copper 1 ppm, chromium tin 1 ppm, magnesium 2.5 ppm, manganese 1 ppm, molybdenum 1 ppm, silver 1 ppm, lead 1 ppm, potassium 1 ppm, titanium 1 ppm, vanadium 1 ppm, paraffin 1 ppm, naphthene-olefin, aromatic, benzene, toluene xylene butadiene water.

In another embodiment a computer-implemented method for the control of the conversion of plastic waste into commodities includes a number of steps. The method involves identifying markets in developed countries and collecting plastic waste from identified markets. Plastic waste data is generated and input to a blockchain network. Appropriate Basel regulations are considered and compliance is established. The software manages and directs the transfer of the plastic waste data and Basel regulations through the blockchain network and establishes contracts with a host nation. The software measures and balances capacity of the host nation. Specific types of plastic waste are distributed based on the capacity and load balancing and the plastic waste is then converted into commodities and carbon credits.

These and other non-limiting features or characteristics of the present disclosure will be further described below.

### BRIEF DESCRIPTION OF DRAWINGS

FIG. 1 is a diagram of a pyrolysis system of the present disclosure.

### DETAILED DESCRIPTION

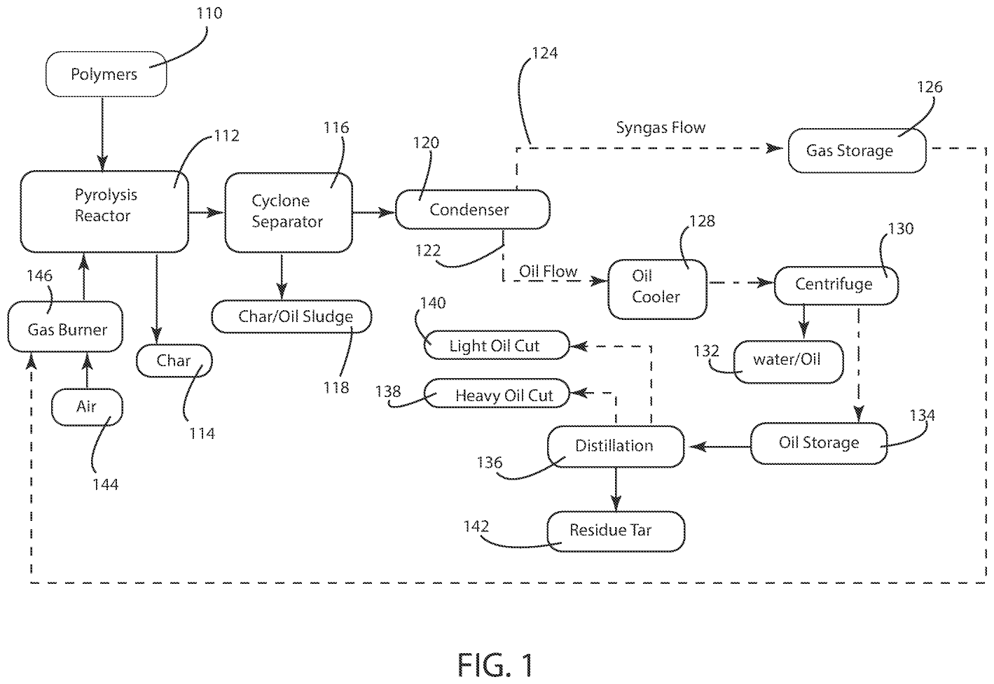

Referring to FIG. 1 polymers 110 are selected and sourced and entered into the pyrolysis reactor 112. Air 144 and heat from a gas burner 146 enter the pyrolysis reactor 112. Material exits the pyrolysis reactor 112 and is moved to a cyclone separator 116 where char and oil sludge 118 are separated out while remaining material is sent to a condenser 120 that separates out syngas that flows along dashed line 124 and oil that flows along a second dashed line 122. Syngas flows into a gas storage container 126 and is used to combine with gas burner 146 and air 144 to continue to power the pyrolysis reactor 112. Oil flow 122 continues to an oil cooler 128 whereafter it is sent to a centrifuge 130 where watery oil 132 is separated out and oil is sent to an oil storage container 134. Oil is then sent through a distillation process 136 where it is separated into heavy oil 138 and light oil 140 and residue tar 142.

Sensors at locations 112, 114, 116, 118, 120, 126,132, 138, 140, and 142 feed data into the method's software-controlled chemical pyrolysis process assessment system, collecting data from each Pyrolysis manufacturing system, using multiple air, liquid, solid, and gas sensors generating data on the temperature, pressure volatility, btu, time present and concentration density of, Sulfur, Nitrogen, Chlorine, Fluoride, Bromine, Pour Point, Phosphorous, Silicon, Mercury, Arsenic, Lead, Boiling Point, Calorific value, Asphaltenes, Barium, Iron, Zinc, Sodium, Nickel, Aluminum, Cadmium, Calcium, Copper, Chromium, Tin, Manganese, Molybdenum, Potassium, Titanium, Vanadium, Paraffin, Napthene-olephon, Aromatic, Diene Index, Flash Point, Benzene, Tolulene, Xylene, Butadiene, and Water.

Based on this sensor collected data, the method analyses the demand needs of a specific pyrolysis system, requiring specific polymers selected from the group consisting of Polyethylene Terephthalate, High Density Polyethelene, Polyvinyl Chloride, Low-Density Polyethelene, Linear Low-Density Polyethelene, Polypropylene, Polystyrene, Acrylic, Nylon, PolyCarbonate, and Polylactic Acid) required to optimize a specific system at a given moment in time, relative to the plastic polymer input demand needs of all pyrolysis systems in the network.

The method determines the optimal routing of available recycled plastic supply, at the optimized polymer level from suppliers, across all PCN manufacturing locations, to direct the optimized blend of polymer supply to each of the pyrolysis manufacturing sites, while simultaneously tracking the origin and destination of the recycled plastic using blockchain technology.

The density/percentage of the aforementioned chemicals is translated into a deficiency of or abundance of plastics chosen from the group: Polyethylene Terephthalate, High Density Polyethelene, Polyvinyl Chloride, Low-Density Polyethelene, Linear Low-Density Polyethelene, Polypropylene, Polystyrene, Acrylic, Nylon, PolyCarbonate, and Polylactic Acid.

The resultant deficiencies are logged into a PCN as demand and resultant abundances are listed as available stock wherein the PCN fills demand with available stock.

A more complete understanding of the components, processes, and apparatuses disclosed herein can be obtained by reference to the accompanying figures. These figures are intended to demonstrate the present disclosure and are not intended to show relative sizes and dimensions or to limit the scope of the exemplary embodiments.

Although specific terms are used in the following description, these terms are intended to refer only to particular structures in the drawings and are not intended to limit the scope of the present disclosure. It is to be understood that like numeric designations refer to components of like function.

1. A computer-implemented method for the control of the conversion of plastic waste into commodities, the method comprising:
loading an amount of polymers into a pyrolysis apparatus engaged with a plurality of sensors; and
collecting data from said plurality of sensors; and
sending said collected data from said plurality of sensors to a central processing unit storing instructions; and
analyzing said data according to said instructions to determine fluid and solid chemical traits of said amount of polymers; and
determining chemical reactions in said pyrolysis apparatus from said chemical traits; and
identifying a chemical ratio by said chemical reactions; and
referencing an ideal chemical ratio; and
determining deficiency of chemicals in said identified chemical ratio with reference to said ideal chemical ratio; and
determining abundance of chemicals in said identified chemical ratio with reference to said ideal chemical ratio
sourcing polymers having chemical properties according to determined abundance and determined deficiency; and
adding said sourced polymers to achieve said ideal ratio; and
converting said amount of polymers according to said ideal chemical ratio.

2. The method of claim 1 further comprising:
transferring said converted polymers to appropriate markets.

3. The method of claim 1 wherein said ideal chemical ratio is selected from the group consisting of:
sulfur, nitrogen, chlorine, fluoride, bromine, asphaltenes, phosphorus, silicon, boron, barium, iron, zinc, sodium, nickel, aluminum, cadmium, calcium, copper, chromium, tin, magnesium, manganese, molybdenum, silver, lead, potassium, titanium, vanadium, paraffin, naphthene-olefin,
aromatic, benzene, toluene, xylene, butadiene, water.

4. The method of claim 1 wherein said ideal chemical ratio is:
sulfur 10000 ppm, nitrogen 1000 ppm, chlorine 200 ppm, fluoride 5 ppm, bromine 10 ppm, asphaltenes, phosphorus 30 ppm, silicon 80 ppm, boron 2.5 ppm, barium 1 ppm, iron 5 ppm, zinc 1 ppm, sodium 2.5 ppm, nickel 1 ppm, aluminum 2.5 ppm, cadmium 1 ppm, calcium 2.5 ppm, copper 1 ppm, chromium tin 1 ppm, magnesium 2.5 ppm, manganese 1 ppm, molybdenum 1 ppm, silver 1 ppm, lead 1 ppm, potassium 1 ppm, titanium 1 ppm, vanadium 1 ppm, paraffin 1 ppm, naphthene-olefin, aromatic, benzene, toluene xylene butadiene water.

5. A computer-implemented method for the conversion of plastic waste into commodities, the method comprising:
identifying markets in developed countries; and
collecting plastic waste from identified markets; and
generating plastic waste data; and
inputting plastic waste data into a blockchain network; and
determining appropriate Basel regulations; and
establishing compliance with said Basel regulations; and
managing and directing the transfer of said plastic waste data and said Basel regulations through said blockchain network; and
establishing contracts with at least one host nation; and
measuring capacity of said at least one host nation; and
balancing load according to said measured capacity; and
distributing said plastic waste according to said load balancing based on said measured capacity; and
converting said plastic waste into commodities; and
converting said plastic waste into plastic/carbon credits; wherein
social benefits including energy security, cleantech jobs and local recycling are provided to host nations.
